(19) United States
(12) Patent Application Publication
(10) Pub. No.: US 2017/0109710 A1
(43) Pub. Date: Apr. 20, 2017

(54) METHOD FOR PROVIDING SCHEDULE AND ELECTRONIC DEVICE SUPPORTING THE SAME

(71) Applicant: Samsung Electronics Co., Ltd, Gyeonggi-do (KR)

(72) Inventor: Hong Ryeol Gil, Seoul (KR)

(21) Appl. No.: 15/294,639

(22) Filed: Oct. 14, 2016

(30) Foreign Application Priority Data
Oct. 16, 2015 (KR) 10-2015-0144941

(51) Int. Cl. G06Q 10/10; H04L 12/58

(52) U.S. Cl. CPC G06Q 10/1095; H04L 51/046

(57) ABSTRACT

An electronic device includes a memory that stores a plurality of sets of bit data including each set of bit data stored in connection with schedule information about one or more schedules, and a processor. The processor is configured to identify first schedule information, to identify a first set of bit data from among the plurality of sets of bit data, to identify at least a second set of bit data from among the plurality of sets of bit data based at least on the first set of bit data, to select second schedule information of one or more pieces of schedule information, and to provide a schedule included in the second schedule information as a recommended schedule in connection with the first schedule information.

### CROSS-REFERENCE TO RELATED APPLICATION(S) AND CLAIM OF PRIORITY

The present application is related to and claims the benefit under 35 U.S.C. §119(a) of a Korean patent application filed on Oct. 16, 2015 in the Korean Intellectual Property Office and assigned Serial number 10-2015-0144941, the entire disclosure of which is hereby incorporated by reference.

### TECHNICAL FIELD

The present disclosure relates to a method for providing a schedule and an electronic device supporting the same.

### BACKGROUND

An electronic device such as a smartphone, a tablet PC, or the like performs various functions: data communication, media playback, schedule management, and the like. The electronic device may store a schedule of a user through a calendar application, a schedule application, or the like. If a scheduled time arrives, the electronic device may notify the user of the upcoming schedule in a variety of output manners such as a popup, sound, vibration, and the like.

In the case where schedule or reservation information is previously stored by the user, a conventional electronic device may generate a simple notification (e.g., a popup or vibration) at a scheduled time point. In the case where there is no stored schedule, the electronic device may not execute a special task.

### SUMMARY

To address the above-discussed deficiencies, it is a primary object to provide a schedule information provision method for storing a schedule extracted from a schedule, a message, an email, or the like, which a user stores, in connection with other previous schedules and for providing an appropriate recommended schedule based on a behavior pattern or a schedule pattern of the user in the case where the user has no upcoming schedule, and an electronic device supporting the same.

In accordance with an aspect of the present disclosure, an electronic device includes a memory configured to store a plurality of sets of bit data including each set of bit data stored in connection with schedule information about one or more schedules, and a processor. The processor is configured to identify first schedule information corresponding to a user of the electronic device, to identify a first set of bit data, that corresponds to the first schedule information, from among the plurality of sets of bit data, to identify at least a second set of bit data, that is associated with the first schedule information, from among the plurality of sets of bit data based at least on the first set of bit data, to select second schedule information of one or more pieces of schedule information stored in connection with the at least a second set of bit data, and to provide a schedule included in the second schedule information as a recommended schedule in connection with the first schedule information.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of an electronic device in a network environment, according to various embodiments;

FIG. 2 illustrates a configuration of a schedule provision module, according to various embodiments;

FIG. 3A illustrates a flowchart for describing a schedule information provision method, according to various embodiments;

FIG. 3B illustrates a flowchart for describing a schedule information provision method based on whether an upcoming schedule is stored, according to various embodiments;

FIG. 4 illustrates an exemplary diagram for describing storing and searching for a schedule, according to various embodiments;

FIG. 5 illustrates a flowchart of a method of determining a recommended schedule, according to various embodiments;

FIG. 6 illustrates an exemplary diagram of a schedule output, according to various embodiments;

FIG. 7 illustrates a block diagram of an electronic device, according to various embodiments; and

FIG. 8 illustrates a block diagram of a program module, according to various embodiments.

Throughout the drawings, it should be noted that like reference numbers are used to depict the same or similar elements, features, and structures.

### DETAILED DESCRIPTION

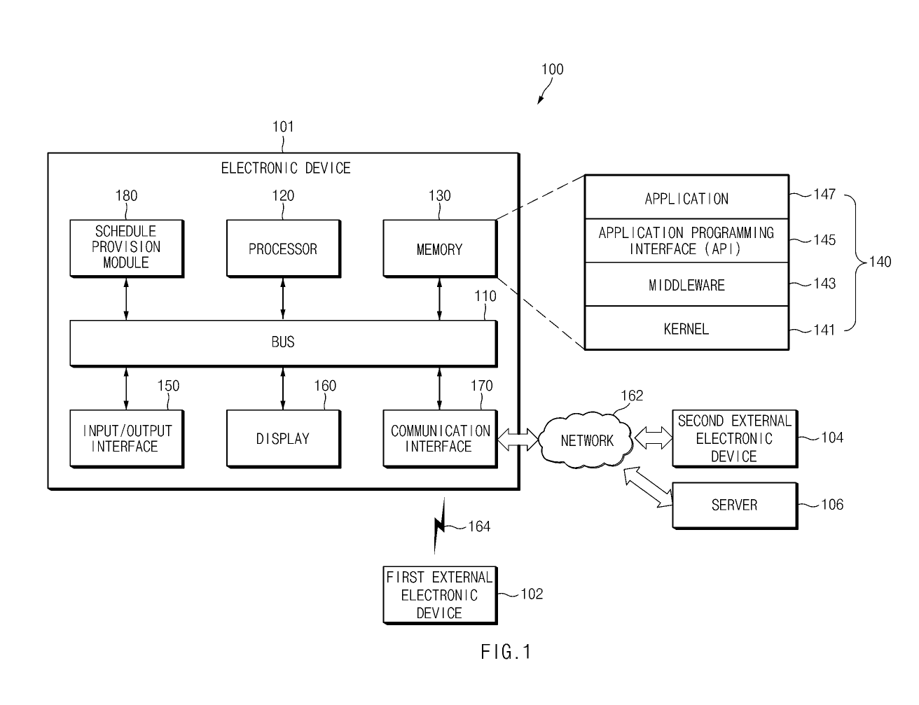

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the present disclosure will be described with reference to the accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. CPU, for example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. According to various embodiments of the present disclosure, the wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of various home appliances. The home appliances may include, for example, at least one of a digital video disk (DVD) player, an audio, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MM) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller's machine (ATM) of a financial company, a point of sales (POS) of a store, or an internet of things (for example, a bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). In various embodiments of the present disclosure, the electronic device may be one or a combination of the aforementioned devices. The electronic device according to some embodiments of the present disclosure may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial electronic device) that uses an electronic device.

Referring to FIG. 1, there is illustrated an electronic device 101 in a network environment 100 according to various embodiments. The electronic device 101 may include a bus 110, a processor 120, a memory 130, an input/output (I/O) interface 150, a display 160, and a communication interface 170. According to an embodiment, the electronic device 101 may not include at least one of the above-described elements or may further include other element(s).

For example, the bus 110 may interconnect the above-described elements 120 to 170 and may include a circuit for conveying communications (e.g., a control message and/or data) among the above-described elements.

The processor 120 (e.g., the processor 110 of FIG. 1) may include one or more of a central processing unit (CPU), an application processor (AP), or a communication processor (CP). The processor 120 may perform, for example, data processing or an operation associated with control and/or communication of at least one other element(s) of the electronic device 101.

The memory 130 may include a volatile and/or nonvolatile memory. For example, the memory 130 may store instructions or data associated with at least one other element(s) of the electronic device 101. According to an embodiment, the memory 130 may store software and/or a program 140. The program 140 may include, for example, a kernel 141, a middleware 143, an application programming interface (API) 145, and/or an application program (or “application”) 147. At least a part of the kernel 141, the middleware 143, or the API 145 may be called an “operating system (OS)”.

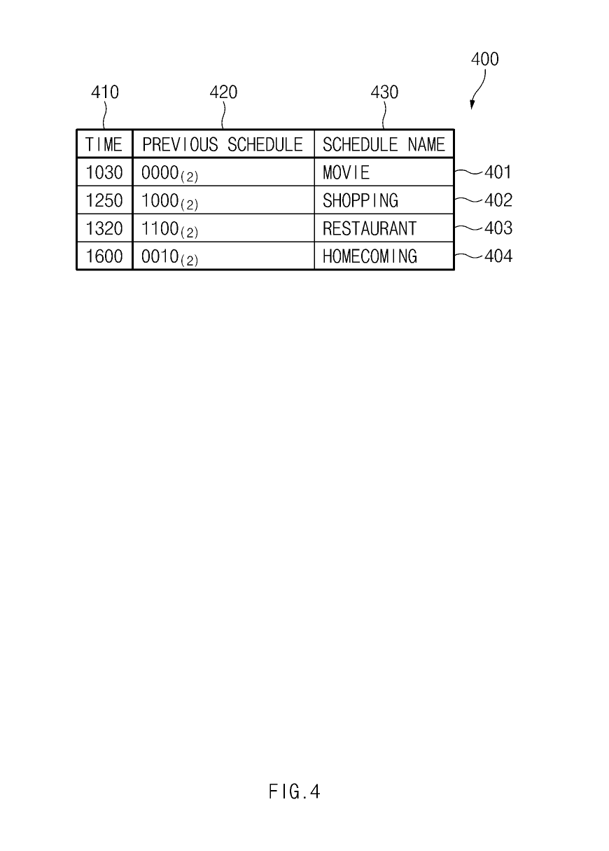

According to various embodiments, a memory 130 may include a memory (e.g., a database) that stores schedule information. The database may include information about a scheduled time, a schedule or appointment name, and the like of each schedule. According to various embodiments, the database may store a schedule together with information about a previous schedule that precedes each schedule. For example, in the case where a first schedule (a movie), a second schedule (shopping), and a third schedule (a restaurant) sequentially occur within a specified time period, the second schedule (shopping) may be stored together with identification information (e.g., an identifier) about the first schedule (a movie), and the third schedule (a restaurant) may be stored together with the identification information (e.g., identifier) of the first schedule (a movie) and the second schedule (shopping). The method for storing the schedule information in the database may be additionally described with reference to FIG. 4.

The kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 101 so as to control or manage system resources.

The middleware 143 may perform a mediation role such that the API 145 or the application program 147 communicates with the kernel 141 to exchange data.

Furthermore, the middleware 143 may process one or more task requests received from the application program 147 according to a priority. For example, the middleware 143 may assign the priority, which makes it possible to use a system resource (e.g., the bus 110, the processor 120, the memory 130, or the like) of the electronic device 101, to at least one of the application program 147. For example, the middleware 143 may process the one or more task requests according to the priority assigned to the at least one application program 147, which makes it possible to perform scheduling or load balancing on the one or more task requests.

The API 145 may be an interface through which the application 147 controls a function provided by the kernel 141 or the middleware 143, and may include, for example, at least one interface or function (e.g., an instruction) for a file control, a window control, image processing, a character control, or the like.

The I/O interface 150 may transmit an instruction or data, input from a user or another external device, to other element(s) of the electronic device 101. Furthermore, the I/O interface 150 may output an instruction or data, received from other element(s) of the electronic device 101, to a user or another external device.

The display 160 may include, for example, a liquid crystal display (LCD), a light-emitting diode (LED) display, an organic LED (OLED) display, a microelectromechanical systems (MEMS) display, or an electronic paper display. The display 160 may display, for example, various kinds of content (e.g., a text, an image, a video, an icon, a symbol, and the like) to a user. The display 160 may include a touch screen and may receive, for example, a touch, gesture, proximity, or hovering input using an electronic pen or a portion of a user's body.

The communication interface 170 may establish communication between the electronic device 101 and an external device (e.g., a first external electronic device 102, a second external electronic device 104, or a server 106). For example, the communication interface 170 may be connected to a network 162 through wireless communication or wired communication to communicate with an external device (e.g., the second external electronic device 104 or the server 106).

The wireless communication may include at least one of, for example, LTE (long-term evolution), LTE-A (LTE Advance), CDMA (Code Division Multiple Access), WCDMA (Wideband CDMA), UMTS (Universal Mobile Telecommunications System), WiBro (Wireless Broadband), GSM (Global System for Mobile Communications), or the like, as a cellular communication protocol. Furthermore, the wireless communication may include, for example, a local area network 164. The local area network 164 may include at least one of a Wi-Fi, a near field communication (NFC), a global navigation satellite system (GNSS), or the like. The GNSS may include at least one of a global positioning system (GPS), a global navigation satellite system (Glonass), Beidou Navigation Satellite System (hereinafter referred to as “Beidou”), the European global satellite-based navigation system (Galileo), or the like. In this specification, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 162 may include at least one telecommunications network, for example, a computer network (e.g., LAN or WAN), an Internet, or a telephone network.

Each of the first and second external electronic devices 102 and 104 may be a device of which the type is different from or the same as that of the electronic device 101. According to an embodiment, the server 106 may include a group of one or more servers. According to various embodiments, all or a portion of operations that the electronic device 101 will perform may be executed by another or plural electronic devices (e.g., the electronic devices 102 and 104 or the server 106). According to an embodiment, in the case where the electronic device 101 executes any function or service automatically or in response to a request, the electronic device 101 may choose not perform the function or the service internally, but, alternatively, it may request at least a part of a function associated with the electronic device 101 at other device (e.g., the electronic device 102 or 104 or the server 106). The other electronic device (e.g., the electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

According to various embodiments, an external device (e.g., a second external electronic device 104 or a server 106) may provide the electronic device 101 with the schedule information of a user. The schedule information may be used to provide a recommended schedule by analyzing a schedule pattern or a behavior pattern of the user.

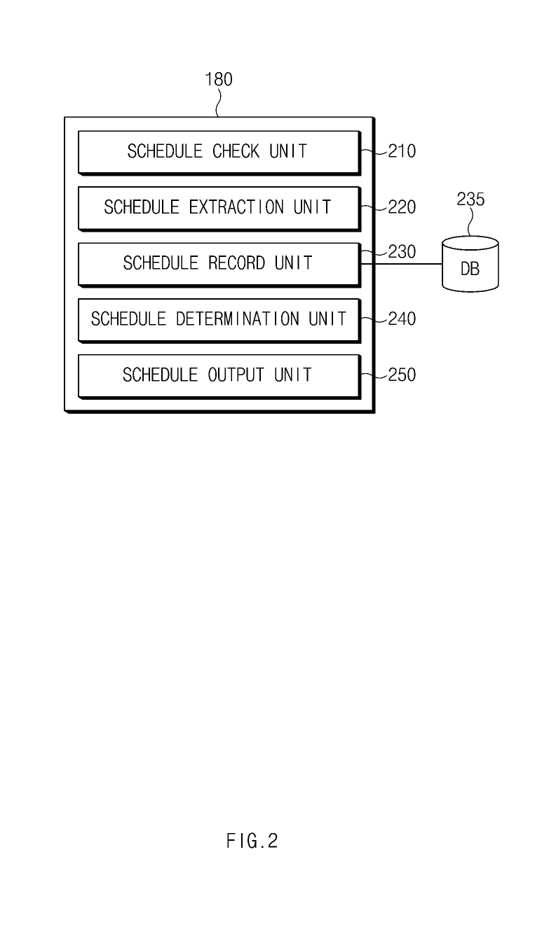

A schedule provision module 180 may output the schedule that a user stores or may output the schedule extracted from a message, an email, or the like. The schedule provision module 180 may output additional information (e.g., information about a nearby restaurant, map information, or the like) associated with the stored schedule or the extracted schedule together with the schedule that a user stores or the schedule extracted from a message, an email, or the like. According to various embodiments, the schedule provision module 180 may provide the user with a recommended schedule based on information (hereinafter referred to as “previous schedule information”) about the previous schedule that precedes a schedule included in the stored schedule or the extracted schedule. The schedule provision module 180 may be additionally described with reference to FIGS. 2 to 9.

In FIG. 1, it is illustrated that the schedule provision module 180 is divided from the processor 120 or memory 130. However, embodiments of the present disclosure are not limited thereto. For example, the schedule provision module 180 may be included as a part of the processor 120. As another example, the schedule provision module 180 may be a function stored in the memory 130 and may perform a procedure that provides the recommended schedule in response to a call of the processor 120.

FIG. 2 illustrates a configuration of a schedule provision module, according to various embodiments.

Referring to FIG. 2, the schedule provision module 180 may include a schedule check unit 210, a schedule extraction unit 220, a schedule record unit 230, a schedule determination unit 240, and a schedule output unit 250.

According to an embodiment, the schedule check unit 210 may collect schedule information stored in, for example, a schedule management application, a calendar application, a memo application, or the like. For example, in the case where a user stores a time of an upcoming schedule and a schedule name after the user executes a schedule management application, the schedule check unit 210 may determine information about the stored schedule through the schedule management application. According to an embodiment, the schedule check unit 210 may determine previous schedule information recorded in a previous instance of each appointment or event in the schedule and may provide relevant information to the schedule record unit 230. According to various embodiments, the schedule check unit 210 may provide the previous schedule information, which is included within a reference time period (e.g., about 3 hours) that is previously set, to the schedule record unit 230 together with each schedule.

According to various embodiments, the schedule check unit 210 may collect the schedule information provided from an external electronic device (e.g., the first external electronic device 102, the second external electronic device 104, or the server 106 in FIG. 1) of an electronic device (e.g., the electronic device 101). For example, the schedule check unit 210 may download the schedule information of the user stored in an external cloud server (e.g., the server 106) and may provide the schedule information to the schedule record unit 230. As another example, the schedule check unit 210 may receive the schedule information stored in a wearable device (e.g., a smart watch) that operates in conjunction with the electronic device and may provide the schedule information to the schedule record unit 230.

According to an embodiment, the schedule extraction unit 220 may extract schedule information from a text output through a display of the electronic device. The schedule extraction unit 220 may extract the schedule information by parsing the text included in, for example, a message application, a social network service (SNS) application, an email application, or the like.

For example, in the case where the user has a conversation such as “we'll meet in restaurant A at 10 o'clock tomorrow” with a counterpart through a message application, the schedule extraction unit 220 may parse the text to collect information such as ‘tomorrow’, ‘restaurant A, and ‘10 o'clock’. According to various embodiments, the schedule extraction unit 220 may change a portion of data. In the embodiment described above, the schedule extraction unit 220 may convert ‘tomorrow’ into ‘20150915’ and may convert ‘10 o'clock’ into ‘1000’. The schedule extraction unit 220 may provide the schedule record unit 230 with information of ‘20150915’, ‘1000’, ‘restaurant A’, and the like. According to various embodiments, the schedule check unit 210 may provide the schedule record unit 230 with the previous schedule information, which is included within the reference time period (e.g., 3 hours) that is previously set, together with each schedule.

According to an embodiment, the schedule record unit 230 may store the schedule information including the previous schedule information provided from the schedule check unit 210 or the schedule extraction unit 220 in a database 235 (e.g., a memory). The schedule record unit 230 may store a previous schedule that precedes each schedule and each schedule included in the schedule information, so as to be connected to each other. According to various embodiments, the schedule record unit 230 may store a schedule by using a set of bit data (e.g., a bit mask code) corresponding to each previous schedule. How to store the schedule using the set of bit data (e.g., a bit mask) will be additionally described with reference to FIG. 4.

According to various embodiments, the database 235 may store the schedule information of the user in connection with the previous schedule. For example, the database 235 may store a schedule name, date information, time information, previous schedule identification information, or the like associated with each schedule. According to various embodiments, the database 235 may be implemented with a part of the memory 130 in FIG. 1 or may be implemented to be independent of the memory 130.

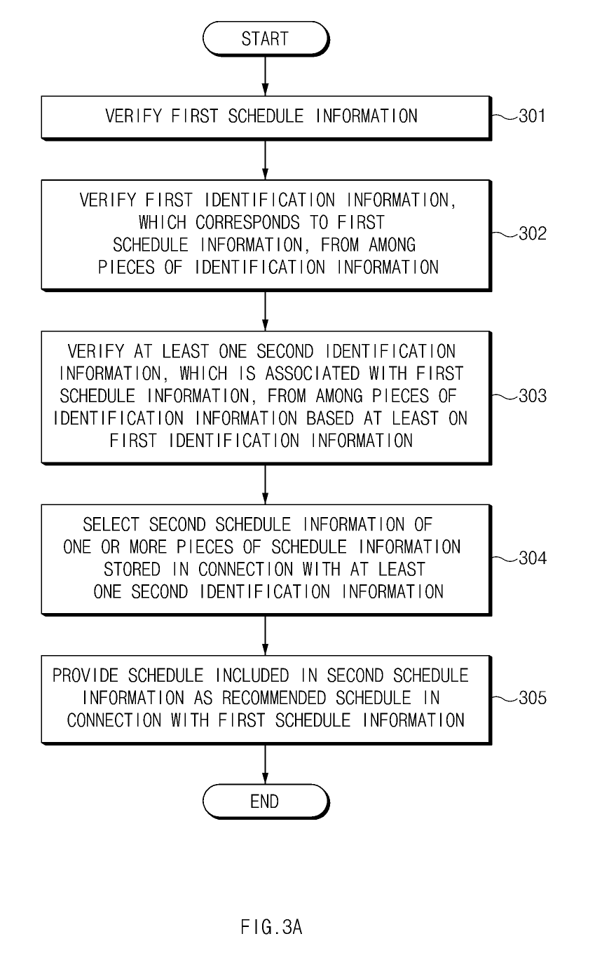

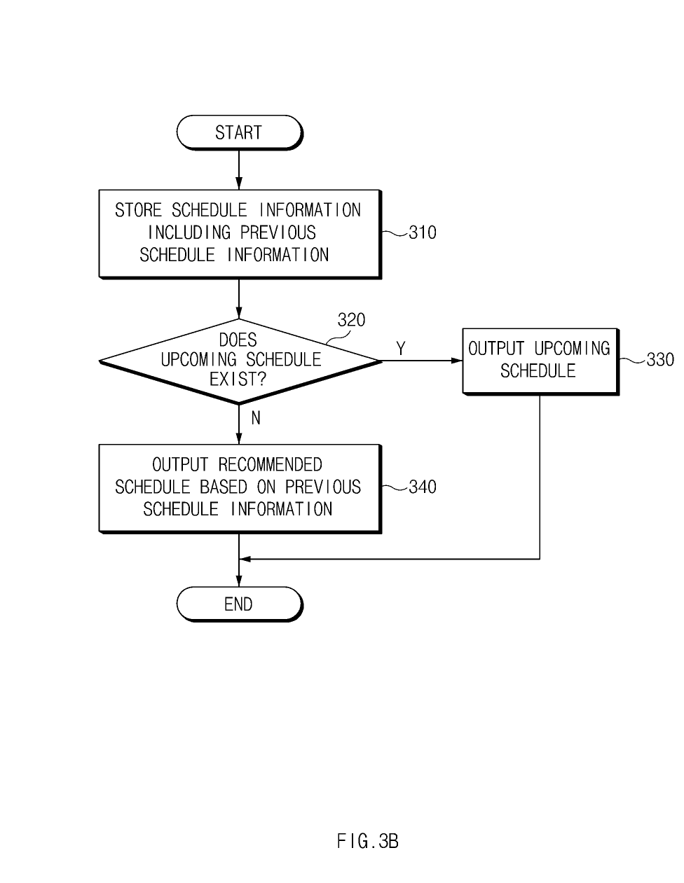

According to an embodiment, the schedule determination unit 240 may determine a schedule to be provided to the user. In the case where the upcoming schedule is previously stored in a schedule management application, a calendar application, or the like until the next notification time (e.g., after about 3 hours), the schedule determination unit 240 may determine the upcoming schedule as the schedule to be provided to the user at a point in time (hereinafter referred to as a ‘notification time’) (e.g., on time every hour), at which a notification is provided to the user. On the other hand, according to an embodiment, in the case where a previously stored schedule does not exist until the next notification time, the schedule determination unit 240 may determine a recommended schedule by using the previous schedule information. According to an embodiment, the schedule determination unit 240 may search for the schedule stored in the database 235 based on a specified condition and may recommend the schedule, which has a high possibility that the user executes the schedule, to the user based on the found schedule. Information about determining the recommended schedule of the schedule determination unit 240 may be provided through FIGS. 3 to 5.

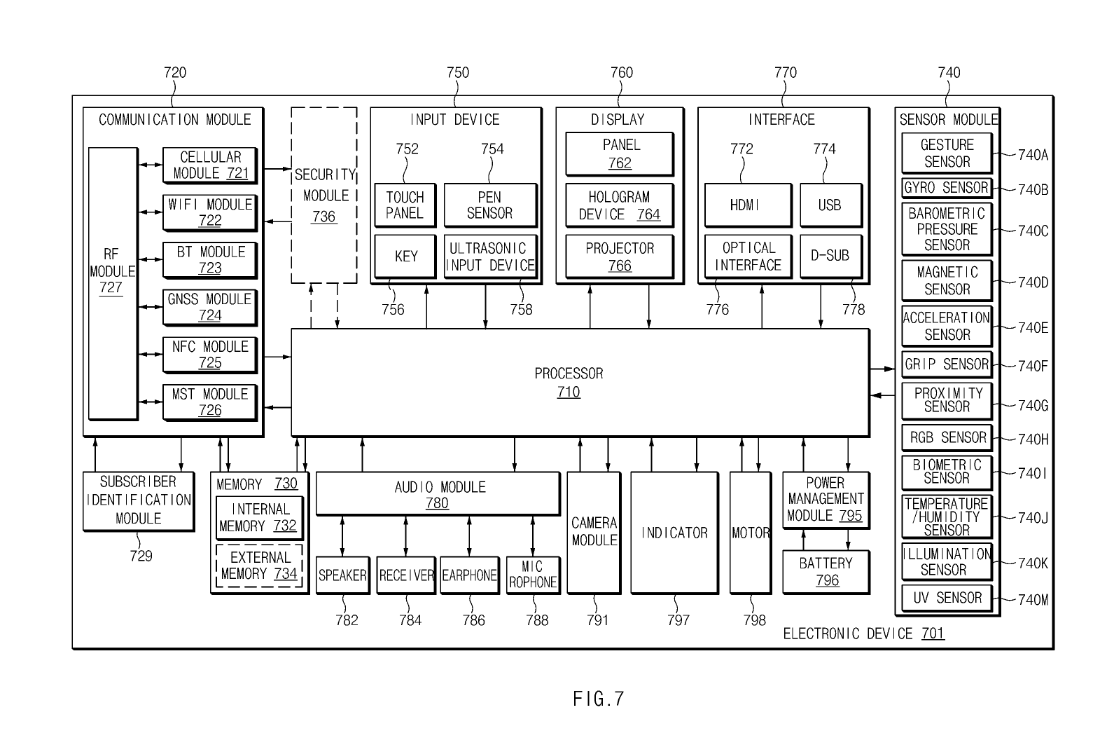

According to an embodiment, the schedule output unit 250 may output the schedule selected by the schedule determination unit 240. The schedule output unit 250 may output the schedule to the user through at least one of, for example, a popup notification, a voice notification, or a vibration notification. According to various embodiments, the schedule output unit 250 may provide additional information associated with the schedule together with the schedule. Information about an output form of the schedule output unit 250 may be provided through FIG. 7.

According to an embodiment, an electronic device may include a memory configured to store a plurality of sets of bit data wherein each set of bit data is stored in connection with schedule information about one or more schedules. The electronic device may also include a processor, wherein the processor is configured to identify first schedule information corresponding to a user of the electronic device, identify a first set of bit data, which corresponds to the first schedule information, from among the plurality of sets of bit data, identify at least a second set of bit data, which is associated with the first schedule information, from among the plurality of sets of bit data based at least on the first set of bit data, select second schedule information of one or more pieces of schedule information stored in connection with the at least a second set of bit data and provide a schedule included in the second schedule information as a recommended schedule in connection with the first schedule information.

According to an embodiment, the processor may be configured to determine at least one or more sets of bit data, which comprises a bit corresponding to the first schedule information, from among the plurality of sets of bit data as the at least a second set of bit data.

According to an embodiment, the processor may be configured to select schedule information, which corresponds to a second time point belonging to a specified time range from a first time point corresponding to the first schedule information, from among the one or more pieces of schedule information as the second schedule information.

According to an embodiment, the processor may be configured to provide the schedule as the recommended schedule if schedule information associated with the first schedule information is not stored in the memory.

According to an embodiment, the processor may be configured to provide a service corresponding to the recommended schedule.

According to an embodiment, the processor may be configured to execute a first application if the recommended schedule is a first schedule and execute a second application if the recommended schedule is a second schedule.

According to an embodiment, an electronic device may include a processor and a memory configured to store pieces of identification information respectively stored in connection with pieces of schedule information, wherein the processor is configured to identify first schedule information corresponding to a user of the electronic device, identify first identification information, which is stored in connection with the first schedule information, from among the pieces of identification information, identify at least one second identification information, which is associated with the first schedule information, from among the pieces of identification information based at least on the first identification information, select second schedule information of one or more pieces of schedule information stored in connection with the at least second identification information and provide a schedule, which is included in the second schedule information, as a recommended schedule in connection with the first schedule information.

According to an embodiment, the processor is configured to provide the schedule as the recommended schedule if there is no schedule information corresponding to a second time point after a first time point corresponding to the first schedule information.

According to an embodiment, the second identification information is a set of bit data comprising a bit corresponding to the first schedule information.

According to an embodiment, the first identification information is a first set of bit data or a first schedule name stored in connection with the first schedule information, and wherein the second identification information is a second set of bit data or a second schedule name stored in connection with the second schedule information.

According to an embodiment, the processor is configured to determine schedule information, which corresponds to a second time point belonging to a specified time range from a first time point corresponding to the first schedule information, from among the one or more pieces of schedule information as the second schedule information.

FIG. 3A illustrates a flowchart for describing a schedule information provision method, according to various embodiments. According to an embodiment, operation 301 to operation 305 may be performed through an electronic device (e.g., the electronic device 101), a processor (e.g., the processor 120) of the electronic device, or the schedule provision module 180 of the electronic device.

Referring to FIG. 3A, in operation 301, the processor 120 may identify schedule information stored in a memory (e.g., the database 235). According to an embodiment, the processor 120 may identify first schedule information corresponding to a user of the electronic device (e.g., the electronic device 101). For example, the first schedule information may be previous schedule information about a schedule stored by the user or a schedule extracted from an email application, or the like.

In operation 302, the processor 120 may identify first identification information, which is stored in connection with the first schedule information, from among pieces of identification information. According to an embodiment, the processor 120 may use a set of bit data (e.g., a bit mask code) as the identification information. The processor 120 may identify a first set of bit data, which corresponds to the first schedule information, from among the plurality of sets of bit data. For example, in the case where the first schedule information is a ‘restaurant schedule’ indicating that the user visits a restaurant, a set of bit data 0001(2) that is previously set to the restaurant schedule may be the first identification information.

In operation 303, the processor 120 may identify at least one second identification information (e.g., a second set of bit data), which is associated with the first schedule information, from among the pieces of identification information (e.g., a plurality of sets of bit data) based at least on the first identification information. In the embodiment described above, the processor 120 may identify sets of bit data 1001(2) and 1101(2) each of which includes 0001(2) as the previous schedule information.

In operation 304, the processor 120 may select second schedule information of one or more pieces of schedule information stored in connection with the at least one second identification information (e.g., the second set of bit data). In the embodiment described above, the processor 120 may select a ‘movie schedule’ corresponding to the set of bit data 1001(2) and a ‘shopping schedule’ corresponding to the set of bit data 1101(2).

In operation 305, the processor 120 may provide a schedule, which is included in the second schedule information, as a recommended schedule in connection with the first schedule information. In the embodiment described above, the processor 120 may provide the user with the ‘movie schedule’ and the ‘shopping schedule’ as the recommended schedule.

FIG. 3B illustrates a flowchart for a method for providing a schedule information based on whether an upcoming schedule is stored, according to various embodiments. According to an embodiment, operation 310 to operation 340 may be performed through an electronic device (e.g., the electronic device 101), a processor (e.g., the processor 120) of the electronic device, or the schedule provision module 180 of the electronic device.

Referring to FIG. 3B, in operation 310, the electronic device (e.g., the schedule record unit 230) may store the schedule information including previous schedule information in a database (e.g., the database 235). According to an embodiment, the electronic device (e.g., the schedule record unit 230) may receive a schedule of a user from, for example, the schedule check unit 210 or the schedule extraction unit 220. According to an embodiment, the electronic device (e.g., the schedule record unit 230) may continually accumulate the schedule information of the user so as to be established in a database. According to an embodiment, the accumulated schedule information may be used to determine a recommended schedule suitable for the user.

According to various embodiments, the electronic device (e.g., the schedule record unit 230) may receive a schedule name, time information, a previous schedule of each schedule, or the like from, for example, the schedule check unit 210 or the schedule extraction unit 220. For example, the electronic device (e.g., the schedule record unit 230) may receive a first schedule stored in a calendar application and a second schedule extracted from a message. In the case where the previous schedule exists with regard to each of the first schedule and the second schedule, the schedule record unit 230 may also receive information about the previous schedule. In the case where a scheduled time of the first schedule is earlier than that of the second schedule, the schedule record unit 230 may store the first schedule as the previous schedule of the second schedule together with the second schedule. According to various embodiments, the previous schedule may be stored in the bit mask manner. Additional information about a storage method of the bit mask manner may be provided through FIG. 4.

In operation 320, the electronic device (e.g., the schedule determination unit 240) may determine whether the upcoming schedule that exists within a notification time zone (e.g., every hour) is included in the stored schedule. For example, the electronic device (e.g., the schedule determination unit 240) may determine whether the upcoming schedule exists for the next one hour, every hour. The upcoming schedule may be a schedule that is stored after being extracted from a schedule, a message, an email, or the like stored by, for example, a management application, a calendar application, or the like.

In operation 330, in the case where the upcoming schedule exists within the notification time zone (e.g., every hour), the electronic device (e.g., the schedule determination unit 240) may output the upcoming schedule through, for example, the schedule output unit 250. According to various embodiments, the electronic device (e.g., the schedule output unit 250) may output additional information (e.g., a map around an area, a way to go, or the like) about the upcoming schedule together with the upcoming schedule.

In operation 340, in the case where the upcoming schedule does not exist within the notification time zone (e.g., every hour), the electronic device (e.g., the schedule determination unit 240) may determine the recommended schedule that is based on the previous schedule information. According to an embodiment, the electronic device (e.g., the schedule output unit 240) may output the determined recommended schedule.

According to an embodiment, in the case where the upcoming schedule does not exist within the notification time zone (e.g., every hour), the electronic device (e.g., the schedule determination unit 240) may provide the user with the recommended schedule to which a behavior pattern, a schedule pattern, or the like of the user is applied.

For example, the recommended schedule may be determined based on the previous schedule information stored together with each schedule. The previous schedule information may include an identifier (e.g., a code or a schedule name) of the previous schedule included within, for example, a reference time (e.g., 3 hours).

For example, in the case where a first schedule and a second schedule are respectively stored at 12:30 and 13:30 and there is no stored schedule between 14:00 and 15:00, the electronic device (e.g., the schedule provision module 180) may output the first schedule at 12:00 and may output the second schedule at 13:00. Since there is no schedule between 14:00 and 15:00, the electronic device (e.g., the schedule provision module 180) may output the recommended schedule. The recommended schedule may be a schedule, which includes the second schedule in the previous schedule information, of schedules stored in the database 235.

According to an embodiment, the electronic device (e.g., the schedule provision module 180) may search for the schedule that includes the second schedule as the previous schedule. The electronic device (e.g., the schedule provision module 180) may search for the previous schedule stored (e.g., stored in the bit mask manner) in connection with a set of bit data. The additional information about a search using the set of bit data (e.g., in the bit mask manner) may be provided through FIG. 4.

According to an embodiment, a method for providing schedule performed at an electronic device may include identifying first schedule information corresponding to a first time point, determining whether schedule information corresponding to a second time point, which belongs to a specified time range from the first time point, is stored in a memory operatively connected with the electronic device, providing, at the electronic device, a first schedule, which is included in the schedule information, as a recommended schedule corresponding to the second time point in connection with the first schedule information if the schedule information is stored in the memory and if the schedule information is not stored in the memory, selecting second schedule information based on identification information, which is associated with the first schedule information, from among pieces of schedule information stored in the memory and providing a second schedule, which is included in the second schedule information, as the recommended schedule in connection with the first schedule information, at the electronic device.

According to an embodiment, the method for providing schedule may further include obtaining, at an application driven by the electronic device, the second schedule information and storing the second schedule in the memory.

According to an embodiment, the method for providing schedule may further include storing the second schedule information in the memory in connection with the identification information based on execution of a schedule included in the first schedule information and execution of the second schedule within a reference time by a user of the electronic device.

According to an embodiment, the method for providing schedule may further include obtaining the second schedule information from an external device and storing the second schedule information in connection with the identification information.

According to an embodiment, the method for providing schedule may further include extracting the second schedule information from a text output through a display of the electronic device or a message or an email that is sent and received.

According to an embodiment, the method for providing schedule may further include storing another set of bit data, which comprises a bit corresponding to the first schedule, in the memory in connection with the second schedule information if the identification information comprises a set of bit data.

According to an embodiment, the identification information may include at least one of a set of bit data or a schedule name corresponding to the first schedule information.

According to an embodiment, the selecting of the second schedule information may include selecting the second schedule information of the pieces of schedule information further based on time information corresponding to the second schedule information.

According to an embodiment, the providing of the second schedule may include further providing additional information associated with the second schedule.

FIG. 4 illustrates an exemplary diagram for describing storing and searching for a schedule, according to various embodiments. In FIG. 4, it is described that a set of bit data is a bit mask code. However, an embodiment of the present disclosure may not be limited thereto.

Referring to FIG. 4, the electronic device (e.g., the electronic device 101, the schedule provision module 180, or the schedule record unit 230) may store a schedule that is collected through, for example, the schedule check unit 210 or the schedule extraction unit 220.

According to an embodiment, the electronic device (e.g., the schedule check unit 210) may collect schedule information stored in a schedule management application, a calendar application, a memo application, or the like. The schedule check unit 210 may store (e.g., provide the schedule record unit 230 with) previous schedule information, which is included within a reference time period (e.g., about 3 hours) that is previously set, together with each schedule.

According to an embodiment, the electronic device (e.g., the schedule extraction unit 220) may extract the schedule information from a text output through a display of the electronic device. The schedule extraction unit 220 may extract the schedule information by parsing the text included in, for example, a message application, an SMS application, an email application, or the like. The electronic device (e.g., the schedule check unit 210) may store (e.g., provide the schedule record unit 230 with) the previous schedule information, which is included within a reference time period (e.g., about 3 hours) that is previously set, together with each schedule.

According to an embodiment, the electronic device (e.g., the schedule record unit 230) may store schedule data 400 in a database (e.g., the database 235). According to an embodiment, the schedule data 400 may include time information 410, previous schedule information 420, and a schedule name 430. According to various embodiments, the electronic device (e.g., the schedule record unit 230) may store date information, information about a day of the week, or attribute information (e.g., subdivision, division, and main division information about each schedule or the like) together. The electronic device (e.g., the schedule record unit 230) may store, for example, a schedule of a user so as to be established in a database and may accumulatively record the schedule of the user. The recorded information may be used to analyze, for example, a schedule pattern or a behavior pattern of the user.

According to an embodiment, the previous schedule information 420 may indicate the schedule stored at a time that is earlier than a scheduled time of each schedule. The previous schedule information 420 may be stored in connection with, for example, a set of bit data (e.g., in the bit mask manner).

In FIG. 4, the electronic device (e.g., the schedule record unit 230) may store the schedule data 400, which includes a first schedule (e.g., a movie) 401, a second schedule (e.g., shopping) 402, a third schedule (e.g., a restaurant) 403, and a fourth schedule (e.g., homecoming) 404 that sequentially progress, in the database (e.g., the database 235). For example, since there is no previous schedule in the first schedule 401, the previous schedule code of the first schedule 401 may be set to ‘0000’. The first schedule 401 may be stored as the previous schedule within a reference time period (e.g., about 3 hours) from a scheduled time (e.g., 12:50) of the second schedule 402. Accordingly, in a previous schedule code of the second schedule 402, a fourth bit indicating the first schedule 401 may be set to ‘1’. The previous schedule code of the second schedule 402 may be set to ‘1000’.

For example, the first schedule 401 and the second schedule 402 are stored as a previous schedule within the reference time period (e.g., about 3 hours) from a scheduled time (e.g., 13:20) of the third schedule 403. Accordingly, in a previous schedule code of the third schedule 403, the fourth bit indicating the first schedule 401 may be set to ‘1’, and a third bit indicating the second schedule 402 may be set to ‘1’. The previous schedule code of the third schedule 403 may be set to ‘1100’.

For example, the first to third schedules 401 to 403 are stored before a scheduled time (e.g., 16:00) of the fourth schedule 404. However, only the third schedule 403 included within a specified time period of the fourth schedule 404 (e.g., about 3 hours) may be stored as the previous schedule. Accordingly, in a previous schedule code of the fourth schedule 404, a second bit indicating the third schedule 403 may be set to ‘1’. The previous schedule code of the fourth schedule 404 may be set to ‘0010’.

According to various embodiments, the electronic device (e.g., the schedule record unit 230) may store whether the schedule is completed, based on a specified condition. For example, in the first schedule (e.g., the movie) 401, in the case where the user stays at a place, where the first schedule (e.g., the movie) 401 is scheduled, during a specified time (e.g., about 2 hours) (e.g., determining whether the electronic device 101 moves, through a GPS, a Wi-Fi, or the like), the electronic device (e.g., the schedule record unit 230) may determine that the first schedule (e.g., the movie) 401 is completed. Accordingly, the electronic device (e.g., the schedule record unit 230) may record that the schedule is completed together with the first schedule (e.g., the movie) 401. For example, in the fourth schedule 404 (e.g., the homecoming), in the case where an ID of the wireless access point (AP) that the user previously stored is found, the electronic device (e.g., the schedule record unit 230) may determine that the user arrives at home and may determine that the fourth schedule (e.g., the homecoming) 404 is completed. Accordingly, the electronic device (e.g., the schedule record unit 230) may record that the schedule is completed, together with the fourth schedule (e.g., the homecoming) 404. The electronic device may record whether the upcoming schedule is completed, thereby improving accuracy in providing a recommended schedule to the user.

According to various embodiments, the electronic device (e.g., the schedule determination unit 240) may determine the recommended schedule by using the stored schedule data 400. For example, in the case where the user watches a movie from 9:00 to 11:00 and where there is no separate schedule thus stored after 11:00, the electronic device (e.g., the schedule determination unit 240) may search for a schedule for which the previous schedule identifier is a movie (e.g., search for a previous schedule of which the fourth bit is ‘1’) and may determine the recommended schedule. For example, the schedule determination unit 240 may search for ‘1000’ or the ‘movie’ being a previous code corresponding to the movie. The electronic device (e.g., the schedule determination unit 240) may search for a schedule including ‘1000(2)’ being the previous schedule identifier corresponding to the movie in the previous schedule 420 by using, for example, a structured query language (SQL) text expressed below.

select * from Context_Log where Previous_Event & 8

In addition, the electronic device (e.g., the schedule determination unit 240) may search for the ‘movie’ being the previous code corresponding to the movie in the previous schedule 420 by using, for example, the SQL text expressed below.

select * from Context_Log where Previous_Event like “% movie %”

In the schedule data 400, the electronic device (e.g., the schedule determination unit 240) may search for the second schedule 402 (the previous schedule code ‘1000’), which includes ‘1000’ in the previous schedule code, and the third schedule 403 (the previous schedule code ‘1100’). The electronic device (e.g., the schedule determination unit 240) may recommend, to the user, at least one schedule of a shopping schedule or a restaurant schedule as the recommended schedule.

According to various embodiments, the electronic device (e.g., the schedule determination unit 240) may select one of the recommended schedules that are found by using time information. For example, the electronic device (e.g., the schedule determination unit 240) may select the schedule for which a time is fast (or, slow) or which belongs to a specified time range, as the recommended schedule. In the embodiment described above, in the case where the shopping schedule and the restaurant schedule are found as the possible recommended schedules, a time of the shopping schedule may be 12:50, and a time of the restaurant schedule may be 13:20. The restaurant schedule belonging to a specified time range (e.g., between about 13:00 and 14:00) may have a weight greater than a weight of the shopping schedule belonging to another time range (e.g., between about 11:00 and 13:00). The schedule determination unit 240 may recommend, to the user, the restaurant schedule suitable for a current time zone (e.g., about 11:00).

The user may receive the schedule suitable for the behavior pattern or the schedule pattern of the user through the recommended schedule, may identify information provided together if necessary, and may store the information as the schedule. According to various embodiments, the electronic device (e.g., the electronic device 101) may ask whether the user actually progress to the recommended schedule or whether the user executes another schedule and may update the database through the response of the user.

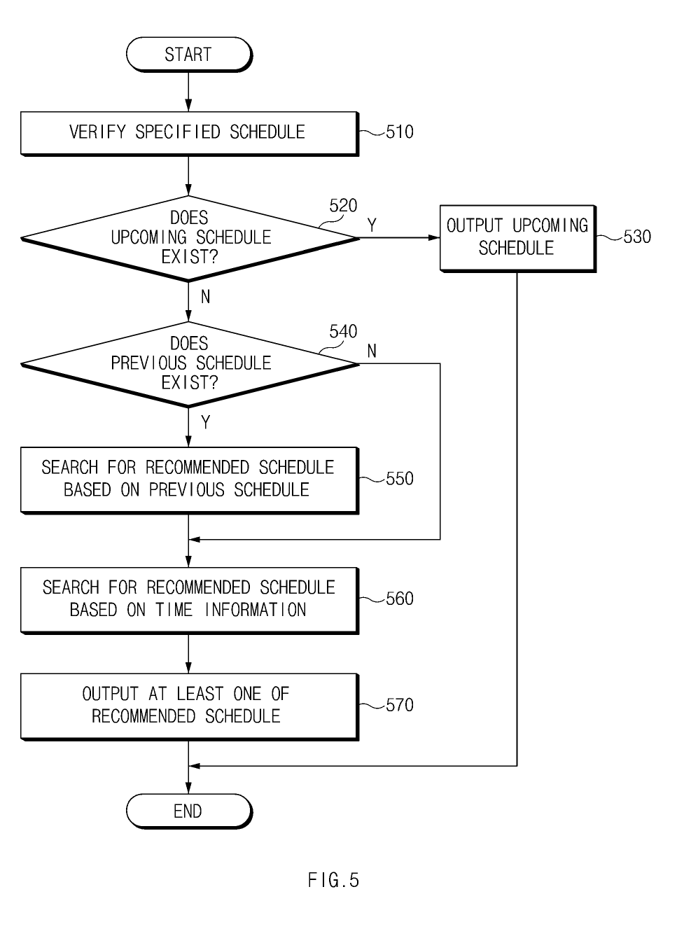

FIG. 5 illustrates a flowchart of a method of determining a recommended schedule, according to various embodiments. The electronic device (e.g., the schedule provision module 180) may provide an upcoming schedule or a recommended schedule to a user at a notification time (e.g., a notification from 08:00 to 20:00 at intervals of about 3 hours). The electronic device (e.g., the schedule provision module 180) may provide the user with a schedule between a current notification time and the next notification time (hereinafter referred to as a “notification time zone”). According to an embodiment, operation 510 to operation 570 may be performed through the electronic device (e.g., the electronic device 101, the processor 120, or the schedule provision module 180).

Referring to FIG. 5, in operation 510, the electronic device (e.g., the schedule provision module 180) may select or determine the schedule stored in a database (e.g., the database 235).

In operation 520, the electronic device (e.g., the schedule provision module 180) may determine whether an upcoming schedule included in the notification time zone exists.

In operation 530, in the case where an upcoming schedule exists in the notification time zone, the electronic device (e.g., the schedule provision module 180) may output the upcoming schedule. For example, the electronic device (e.g., the schedule provision module 180) may output the schedule, which the user stores in a calendar application, through, for example, a display or a speaker.

According to an embodiment, in the case where the upcoming schedule does not exist in the notification time zone, the electronic device (e.g., the schedule provision module 180) may perform a procedure for providing the recommended schedule of operation 540 to operation 570.

In operation 540, the electronic device (e.g., the schedule provision module 180) may determine whether a previous schedule exists before the notification time. For example, in the case where the notification time is 12:00, the electronic device may determine whether a previous schedule exists in a time zone between about 09:00 and 12:00 that is a previous time zone of the notification time. According to various embodiments, in the case where there is no previous schedule, the electronic device may search for a recommended schedule based on time information according to operation 560.

In operation 550, in the case where there is a previous schedule, the electronic device (e.g., the schedule provision module 180) may search for a recommended schedule based on the previous schedule. The electronic device (e.g., the schedule provision module 180) may search for the recommended schedule in the manner using, for example, a bit mask illustrated in FIG. 4. The electronic device (e.g., the schedule provision module 180) may search for the recommended schedule by using, for example, identification information (e.g., a schedule name or a bit mask code) of the previous schedule.

In operation 560, the electronic device (e.g., the schedule provision module 180) may search for a recommended schedule based on the time information. For example, the electronic device (e.g., the schedule provision module 180) may recommend a schedule suitable for a current state of the user, by again searching for a recommended schedule by using the time information in the recommended schedule found through the identification information of the previous schedule. For example, in the case where there is no previous schedule, the electronic device (e.g., the schedule provision module 180) may search for a recommended schedule by using the time information.

According to various embodiments, in the case where a plurality of schedules are found as the recommended schedule, the electronic device (e.g., the schedule provision module 180) may determine the recommended schedule based on a probability.

A=A_{b} ∪ A_{c} ∪ A_{d} For example, when it is assumed that a record set corresponding to a previous event ‘a’ is ‘A’, there may be follow-up events ‘b’, ‘c’, and ‘d’. If a set having the follow-up events ‘b’, ‘c’, and ‘d’ in a set ‘A’ is respectively defined as Ab, Ac, and Ad, the set ‘A’ may be expressed as follows:

‘N’ that is the total number of records having the previous event ‘a’ is as follows:

N=|A|

n_{b} being the number of set A_{b}, n_{c} being the number of set A_{c}, and n_{d} being the number of set A_{d} are as follows.

n_{b}=|A_{b}|, n_{c}|A_{c}|, n_{d}=|A_{d}|

According to an embodiment, the electronic device may check a record, which exists between a current time and a reference time (e.g., about 3 hours), in a database (e.g., the database 235) and may calculate the number of records for each event based on the checked result. For example, in the set ‘T’, if a set having the follow-up event ‘a’ is defined as Tₐ, if a set having the follow-up event ‘b’ is defined as T_{b}, if a set having the follow-up event ‘c’ is defined as T_{c}, and if a set having the follow-up event ‘d’ is defined as T_{d} when the record set, which exists within a reference time period (e.g., 3 hours), is set ‘T’, set ‘T’ may be expressed as follows:

T=Tₐ ∪ T_{b} ∪ T_{c} ∪ T_{d}

‘M’ being the total number of records that exist within the reference time period (e.g., about 3 hours) may be expressed as follows:

M=|T|

mₐ being the number of set Tₐ, m_{b} being the number of set T_{b}, m_{c} being the number of set T_{c}, and m_{d} being the number of set T_{d} are as follows:

mₐ=|Tₐ|, m_{b}=|T_{b}|, m_{c}=|T_{c}|, m_{d}=|T_{d}|

In the case where there is a previous event ‘a’, the electronic device (e.g., the schedule provision module 180) may obtain probabilities P_{b}, P_{c}, and P_{d}, in which the remaining events ‘b’, ‘c’, and ‘d’ other than the previous event ‘a’ respectively become the follow-up events, and may return an event of the greatest value.

$${P}_{b} = \frac{{n}_{b} + {m}_{b}}{N + M} , {P}_{c} = \frac{{n}_{c} + {m}_{c}}{N + M} , {P}_{d} = \frac{{n}_{d} + {m}_{d}}{N + M}$$

In the case where there is no previous event, as described below, the electronic device (e.g., the schedule provision module 180) may obtain probabilities Pₐ, P_{b}, P_{c}, and P_{d} in which the events ‘a’, ‘c’, and ‘d’ respectively become the follow-up events, and may return the greatest value.

$${P}_{a} = \frac{{m}_{a}}{M} , {P}_{b} = \frac{{m}_{b}}{M} , {P}_{c} = \frac{{m}_{c}}{M} , {P}_{d} = \frac{{m}_{d}}{M}$$

In operation 570, the electronic device (e.g., the schedule provision module 180) may output the upcoming schedule or the recommended schedule. According to an embodiment, the electronic device (e.g., the schedule provision module 180) outputs additional information (e.g., map information, information about a nearby shopping mall, or information about a nearby restaurant, or the like) about the upcoming schedule or the recommended schedule together with the output of the upcoming schedule or the recommended schedule.

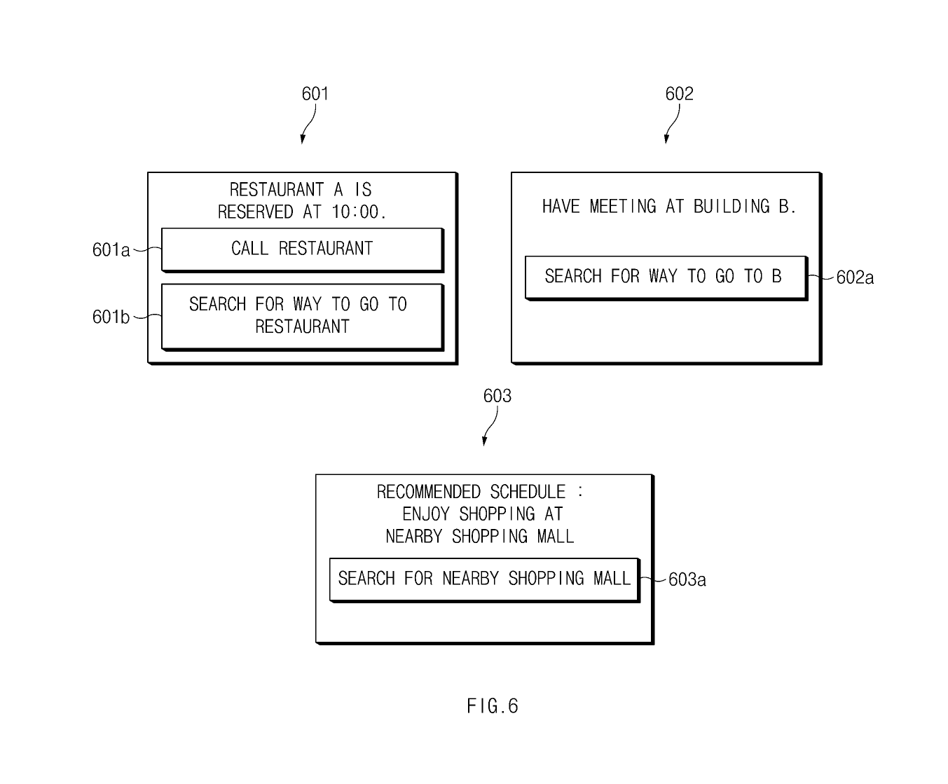

FIG. 6 illustrates an exemplary diagram of a schedule output, according to various embodiments.

Referring to FIG. 6, an electronic device (e.g., the electronic device 101, the processor 120, the schedule provision module 180, or the schedule output unit 250) may output an upcoming schedule or a recommended schedule. In FIG. 6, an embodiment of the present disclosure is exemplified as a schedule is output in the form of a popup. However, an embodiment of the present disclosure may not be limited thereto.

According to an embodiment, in the case where there is an upcoming schedule in a notification time zone, the electronic device (e.g., the schedule output unit 250) may output the upcoming schedule in the form of a popup 601 or 602.

In the popup 601, the electronic device (e.g., the schedule output unit 250) may output a button 601a or 601b for providing additional information together with a text including time information and place information of a schedule to be provided to a user. According to an embodiment, in the case where the user presses the button 601a or 601b by touching the button 601a or 601b, relevant information may be provided.

In the popup 602, the electronic device (e.g., the schedule output unit 250) may output a button 602a for providing the additional information together with a text including place information of the schedule to be provided to the user.

In the case where there is no upcoming schedule in the notification time zone, the electronic device (e.g., the schedule output unit 250) may output the recommended schedule in the form of a popup 603.

In the popup 603, the electronic device (e.g., the schedule output unit 250) may output a button 603a for providing the additional information together with a text including the recommended schedule to be provided to the user.

According to various embodiments, the electronic device (e.g., the schedule output unit 250) may receive the recommended schedule associated with advertisement information, sale coupon information, and the like from an external device (e.g., the server 106 of FIG. 1). Accordingly, the user may receive an advertisement based on a schedule pattern or a behavior pattern of the user and may determine the advertisement in the nonthreatening manner.

FIG. 7 is a block diagram of an electronic device according to various embodiments. An electronic device 701 may include, for example, all or a part of the electronic device 101 illustrated in FIG. 1. The electronic device 701 may include one or more processors (e.g., an application processor (AP)) 710, a communication module 720, a subscriber identification module 729, a memory 730, a sensor module 740, an input device 750, a display 760, an interface 770, an audio module 780, a camera module 791, a power management module 795, a battery 796, an indicator 797, and a motor 798.

The processor 710 may drive an operating system (OS) or an application to control a plurality of hardware or software elements connected to the processor 710 and may process and compute a variety of data. The processor 710 may be implemented with a System on Chip (SoC), for example. According to an embodiment, the processor 710 may further include a graphic processing unit (GPU) and/or an image signal processor. The processor 710 may include at least a part (e.g., a cellular module 721) of elements illustrated in FIG. 7. The processor 710 may load and process an instruction or data, which is received from at least one of other elements (e.g., a nonvolatile memory) and may store a variety of data in a nonvolatile memory.

The communication module 720 may be configured the same as or similar to the communication interface 170 of FIG. 1. The communication module 720 may include a cellular module 721, a Wi-Fi module 722, a Bluetooth (BT) module 723, a GNSS module 724 (e.g., a GPS module, a Glonass module, a Beidou module, or a Galileo module), a near field communication (NFC) module 725, and a radio frequency (RF) module 727.

The cellular module 721 may provide voice communication, video communication, a message service, an Internet service or the like through a communication network. According to an embodiment, the cellular module 721 may perform discrimination and authentication of the electronic device 701 within a communication network using the subscriber identification module 279 (e.g., a SIM card), for example. According to an embodiment, the cellular module 721 may perform at least a portion of functions that the processor 710 provides. According to an embodiment, the cellular module 721 may include a communication processor (CP).

Each of the Wi-Fi module 722, the BT module 723, the GNSS module 724, and the NFC module 725 may include a processor for processing data exchanged through a corresponding module, for example. According to an embodiment, at least a part (e.g., two or more elements) of the cellular module 721, the Wi-Fi module 722, the BT module 723, the GNSS module 724, or the NFC module 725 may be included within one Integrated Circuit (IC) or an IC package.

The RF module 727 may transmit and receive, for example, a communication signal (e.g., an RF signal). The RF module 727 may include, for example, a transceiver, a power amplifier module (PAM), a frequency filter, a low noise amplifier (LNA), an antenna, or the like. According to another embodiment, at least one of the cellular module 721, the Wi-Fi module 722, the BT module 723, the GNSS module 724, or the NFC module 725 may transmit and receive an RF signal through a separate RF module.

The subscriber identification module 729 may include, for example, a card and/or embedded SIM that includes a subscriber identification module and may include unique identifying information (e.g., integrated circuit card identifier (ICCID)) or subscriber information (e.g., international mobile subscriber identity (IMSI)).

The memory 730 (e.g., the memory 130) may include an internal memory 732 or an external memory 734. For example, the internal memory 732 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, or a NOR flash memory), a hard drive, or a solid state drive (SSD).

The external memory 734 may include a flash drive, for example, compact flash (CF), secure digital (SD), micro secure digital (Micro-SD), mini secure digital (Mini-SD), extreme digital (xD), multimedia card (MMC), a memory stick, or the like. The external memory 734 may be functionally and/or physically connected with the electronic device 701 through various interfaces.

The sensor module 740 may measure, for example, a physical quantity or may detect an operation state of the electronic device 701. The sensor module 740 may convert the measured or detected information to an electric signal. The sensor module 740 may include at least one of a gesture sensor 740A, a gyro sensor 740B, a barometric pressure sensor 740C, a magnetic sensor 740D, an acceleration sensor 740E, a grip sensor 740F, a proximity sensor 740G, a color sensor 740H (e.g., red, green, blue (RGB) sensor), a biometric sensor 740I, a temperature/humidity sensor 740J, an illuminance sensor 740K, or an UV sensor 740M. Even though not illustrated, additionally or alternatively, the sensor module 740 may include, for example, an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 740 may further include a control circuit for controlling at least one or more sensors included therein. According to an embodiment, the electronic device 701 may further include a processor which is a part of the processor 710 or independent of the processor 710 and is configured to control the sensor module 740. The processor may control the sensor module 740 while the processor 710 remains at a sleep state.

The input device 750 may include, for example, a touch panel 752, a (digital) pen sensor 754, a key 756, or an ultrasonic input unit 758. The touch panel 752 may use at least one of capacitive, resistive, infrared and ultrasonic detecting methods. Also, the touch panel 752 may further include a control circuit. The touch panel 752 may further include a tactile layer to provide a tactile reaction to a user.

The (digital) pen sensor 754 may be, for example, a portion of a touch panel or may include an additional sheet for recognition. The key 756 may include, for example, a physical button, an optical key, a keypad, or the like. The ultrasonic input device 758 may detect (or sense) an ultrasonic signal, which is generated from an input device, through a microphone (e.g., a microphone 788) and may check data corresponding to the detected ultrasonic signal.

The display 760 (e.g., the display 160) may include a panel 762, a hologram device 764, or a projector 766. The panel 762 may be configured the same as or similar to the display 160 of FIG. 1. The panel 762 may be implemented to be flexible, transparent or wearable, for example. The panel 762 and the touch panel 752 may be integrated into a single module. The hologram device 764 may display a stereoscopic image in a space using a light interference phenomenon. The projector 766 may project light onto a screen so as to display an image. The screen may be arranged inside or outside the electronic device 701. According to an embodiment, the display 760 may further include a control circuit for controlling the panel 762, the hologram device 764, or the projector 766.

The interface 770 may include, for example, a high-definition multimedia interface (HDMI) 772, a universal serial bus (USB) 774, an optical interface 776, or a D-subminiature (D-sub) 778. The interface 770 may be included, for example, in the communication interface 170 illustrated in FIG. 1. Additionally or alternatively, the interface 770 may include, for example, a mobile high definition link (MHL) interface, a SD card/multi-media card (MMC) interface, or an infrared data association (IrDA) standard interface.

The audio module 780 may convert a sound and an electrical signal in dual directions. At least a part of the audio module 780 may be included, for example, in the input/output interface 150 illustrated in FIG. 1. The audio module 780 may process, for example, sound information that is input or output through a speaker 782, a receiver 784, an earphone 786, or a microphone 788.

The camera module 791 for shooting a still image or a video may include, for example, at least one image sensor (e.g., a front sensor or a rear sensor), a lens, an image signal processor (ISP), or a flash (e.g., an LED or a xenon lamp).

The power management module 795 may manage, for example, power of the electronic device 701. According to an embodiment, a power management integrated circuit (PMIC) a charger IC, or a battery or fuel gauge may be included in the power management module 795. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 796 and a voltage, current or temperature thereof while the battery is charged. The battery 796 may include, for example, a rechargeable battery or a solar battery.

The indicator 797 may display a specific state of the electronic device 701 or a part thereof (e.g., the processor 710), such as a booting state, a message state, a charging state, and the like. The motor 798 may convert an electrical signal into a mechanical vibration and may generate a vibration effect, a haptic effect, or the like. Even though not illustrated, a processing device (e.g., a GPU) for supporting a mobile TV may be included in the electronic device 701. The processing device for supporting a mobile TV may process media data according to the standards of digital multimedia broadcasting (DMB), digital video broadcasting (DVB), MediaFlo™, or the like.

Each of the above-mentioned elements may be configured with one or more components, and the names of the elements may be changed according to the type of the electronic device. The electronic device according to various embodiments may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

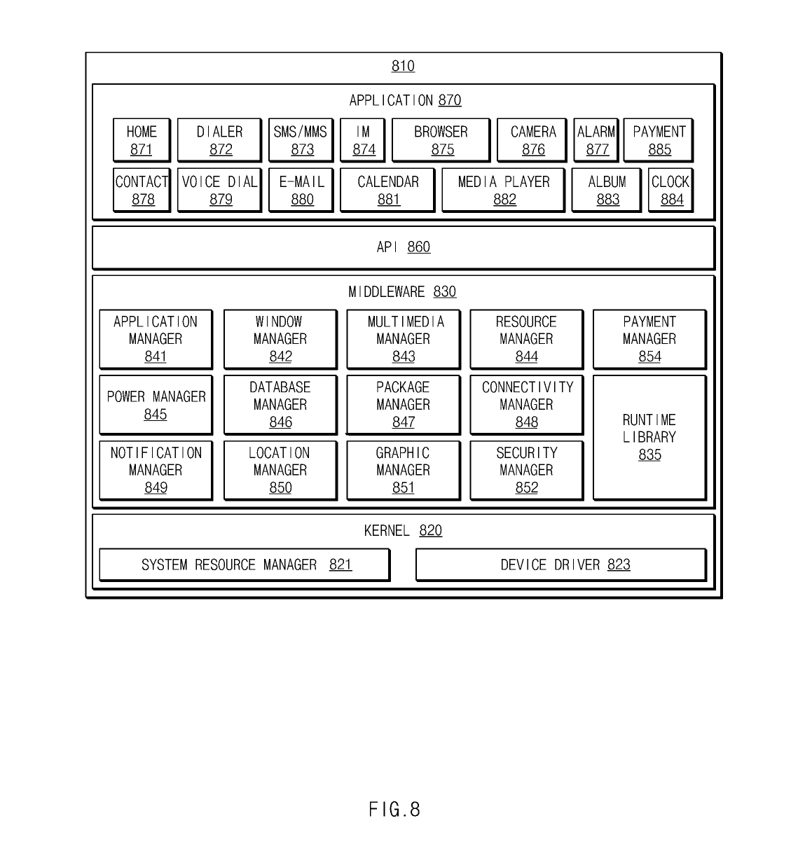

FIG. 8 is a block diagram of a program module according to various embodiments. According to an embodiment, a program module 810 (e.g., the program 140) may include an operating system (OS) to control resources associated with an electronic device (e.g., the electronic device 101) and/or diverse applications (e.g., the application program 147) driven on the OS. The OS may be, for example, android, iOS, windows, symbian, tizen, or bada.

The program module 810 may include a kernel 820, a middleware 830, an application programming interface (API) 860, and/or an application 870. At least a part of the program module 810 may be preloaded on an electronic device or may be downloadable from an external electronic device (e.g., the external device 102, and the like).

The kernel 820 (e.g., the kernel 141) may include, for example, a system resource manager 821 and/or a device driver 823. The system resource manager 821 may perform control, allocation, or retrieval of system resources. According to an embodiment, the system resource manager 821 may include a process managing part, a memory managing part, or a file system managing part. The device driver 823 may include, for example, a display driver, a camera driver, a Bluetooth driver, a shared memory driver, an USB driver, a keypad driver, a Wi-Fi driver, an audio driver, or an inter-process communication (IPC) driver.

The middleware 830 may provide, for example, a function which the application 870 needs in common, or may provide diverse functions to the application 870 through the API 860 to allow the application 870 to efficiently use limited system resources of the electronic device. According to an embodiment, the middleware 830 (e.g., the middleware 143) may include at least one of a runtime library 835, an application manager 841, a window manager 842, a multimedia manager 843, a resource manager 844, a power manager 845, a database manager 846, a package manager 847, a connectivity manager 848, a notification manager 849, a location manager 850, a graphic manager 851, or a security manager 852.

The runtime library 835 may include, for example, a library module which is used by a compiler to add a new function through a programming language while the application 870 is being executed. The runtime library 835 may perform input/output management, memory management, or capacities about arithmetic functions.

The application manager 841 may manage, for example, a life cycle of at least one application of the application 870. The window manager 842 may manage a GUI resource which is used in a screen. The multimedia manager 843 may identify a format for playing diverse media files and may perform encoding or decoding of media files by using a codec suitable for the format. The resource manager 844 may manage resources such as a storage space, memory, or source code of at least one application of the application 870.

The power manager 845 may operate, for example, with a basic input/output system (BIOS) to manage a battery or power and may provide power information for an operation of an electronic device. The database manager 846 may generate, search for, or modify database which is to be used in at least one application of the application 870. The package manager 847 may install or update an application which is distributed in the form of a package file.

The connectivity manager 848 may manage, for example, wireless connection such as Wi-Fi or Bluetooth. The notification manager 849 may display or notify an event such as arrival message, appointment, or proximity notification in a mode that does not disturb a user. The location manager 850 may manage location information of an electronic device. The graphic manager 851 may manage a graphic effect that is provided to a user or manage a user interface relevant thereto. The security manager 852 may provide a general security function useful for system security or user authentication. According to an embodiment, in the case where an electronic device (e.g., the electronic device 101) includes a telephony function, the middleware 830 may further include a telephony manager for managing a voice or video call function of the electronic device.

The middleware 830 may include a middleware module that combines diverse functions of the above-described elements. The middleware 830 may provide a module specialized to each OS kind to provide differentiated functions. Additionally, the middleware 830 may remove a part of the preexisting elements, dynamically, or may add a new element thereto.

The API 860 (e.g., the API 145) may be, for example, a set of programming functions and may be provided with a configuration which is variable depending on an OS. For example, in the case where an OS is android or iOS, it may be permissible to provide one API set per platform. In the case where an OS is tizen, it may be permissible to provide two or more API sets per platform.

The application 870 (e.g., the application program 147) may include, for example, one or more applications capable of providing functions for a home 871, a dialer 872, an SMS/MMS 873, an instant message (IM) 874, a browser 875, a camera 876, an alarm 877, a contact 878, a voice dial 879, an e-mail 880l a calendar 881, a media player 882, an album 883, and a clock 884, or for offering health care (e.g., measuring an exercise quantity or blood sugar) or environment information (e.g., atmospheric pressure, humidity, or temperature).

According to an embodiment, the application 870 may include an application (hereinafter referred to as “information exchanging application” for descriptive convenience) to support information exchange between the electronic device (e.g., the electronic device 101) and an external electronic device (e.g., the electronic device 102 or 104). The information exchanging application may include, for example, a notification relay application for transmitting specific information to the external electronic device, or a device management application for managing the external electronic device.

For example, the notification relay application may include a function of transmitting notification information, which arise from other applications (e.g., applications for SMS/MMS, e-mail, health care, or environmental information), to an external electronic device (e.g., the electronic device 102 or 104). Additionally, the notification relay application may receive, for example, notification information from an external electronic device and provide the notification information to a user.

The device management application may manage (e.g., install, delete, or update), for example, at least one function (e.g., turn-on/turn-off) of an external electronic device itself (or a part of components) or adjustment of brightness (or resolution) of a display of an external electronic device (e.g., the electronic device 102) which communicates with the electronic device, an application running in the external electronic device, or a service (e.g., a call service, a message service, or the like) provided from the external electronic device.

According to an embodiment, the application 870 may include an application (e.g., a health care application of a mobile medical device, and the like) which is assigned in accordance with an attribute of the external electronic device (e.g., the electronic device 102). According to an embodiment, the application 870 may include an application which is received from an external electronic device (e.g., the electronic device 102). According to an embodiment, the application 870 may include a preloaded application or a third party application which is downloadable from a server. The element titles of the program module 810 according to the embodiment may be modifiable depending on kinds of OSs.

According to various embodiments, at least a part of the program module 810 may be implemented by software, firmware, hardware, or a combination of two or more thereof. At least a portion of the program module 810 may be implemented (e.g., executed), for example, by the processor (e.g., the processor 110). At least a portion of the program module 810 may include, for example, a module, a program, a routine, sets of instructions, or a process for performing one or more functions.

The term “module” used in this disclosure may represent, for example, a unit including one or more combinations of hardware, software and firmware. For example, the term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a portion of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 120), may cause the one or more processors to perform a function corresponding to the instruction. The computer-readable storage media, for example, may be the memory 130.

The computer-readable storage media according to various embodiments may store a program for executing an operation in which a communication module receives an application package from an external device and provides the application package to a normal module of a processor, an operation in which the normal module determines whether a secure application is included in at least a portion of the application package, and an operation in which the secure module of the processor installs the secure application in the secure module or in a memory associated with the secure module.

The computer-readable storage media may include a hard disk, a floppy disk, a magnetic media (e.g., a magnetic tape), an optical media (e.g., a compact disc read only memory (CD-ROM) and a digital versatile disc (DVD)), a magneto-optical media (e.g., a floptical disk), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above-mentioned hardware devices may be configured to operate as one or more software modules to perform operations according to various embodiments, and vice versa.

Modules or program modules according to various embodiments may include at least one or more of the above-mentioned elements, some of the above-mentioned elements may be omitted, or other additional elements may be further included therein. Operations executed by modules, program modules, or other elements according to various embodiments may be executed by a successive method, a parallel method, a repeated method, or a heuristic method. Also, a part of operations may be executed in different sequences, omitted, or other operations may be added.

According to various embodiments of the present disclosure, a schedule information provision method and an electronic device supporting the same may record the behavior pattern or the schedule pattern of the user by storing a schedule of the user together with a previous schedule.

According to various embodiments of the present disclosure, the schedule information provision method and the electronic device supporting the same may store the previous schedule in the bit mask manner and may record a substantial schedule pattern with a low capacity by using the previous schedule as the recommended schedule.

According to various embodiments of the present disclosure, the schedule information provision method and the electronic device supporting the same may provide a recommended schedule that is optimized to the user by using the schedule information, to which the behavior pattern or the schedule pattern of the user is applied, and may provide additional information associated with the recommended schedule.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a memory configured to store a plurality of sets of bit data, each set of bit data stored in connection with schedule information about one or more schedules; and
a processor, wherein the processor is configured to:
identify first schedule information corresponding to a user of the electronic device;
identify a first set of bit data that corresponds to the first schedule information from among the plurality of sets of bit data;
identify at least a second set of bit data that is associated with the first schedule information from among the plurality of sets of bit data based at least on the first set of bit data;
select second schedule information from one or more pieces of schedule information stored in connection with the at least second set of bit data; and
provide a schedule included in the second schedule information as a recommended schedule in connection with the first schedule information.

2. The electronic device of claim 1, wherein the processor is configured to determine as the at least a second set of bit data, from among the plurality of sets of bit data, one or more sets of bit data that include a bit corresponding to the first schedule information.

3. The electronic device of claim 1, wherein the processor is configured to select as the second schedule information, from among the one or more pieces of schedule information, schedule information that corresponds to a second time point belonging to a specified time range from a first time point corresponding to the first schedule information.

4. The electronic device of claim 1, wherein the processor is configured to provide the schedule as the recommended schedule if schedule information associated with the first schedule information is not stored in the memory.

5. The electronic device of claim 1, wherein the processor is configured to provide a service corresponding to the recommended schedule.

6. The electronic device of claim 1, wherein the processor is configured to:
execute a first application if the recommended schedule is a first schedule; and
execute a second application if the recommended schedule is a second schedule.

7. An electronic device comprising:
a processor; and
a memory configured to store pieces of identification information respectively stored in connection with pieces of schedule information,
wherein the processor is configured to:
identify first schedule information corresponding to a user of the electronic device;
identify first identification information that is stored in connection with the first schedule information from among the pieces of identification information;
identify at least one second identification information that is associated with the first schedule information from among the pieces of identification information based at least on the first identification information;
select second schedule information of one or more pieces of schedule information stored in connection with the at least one second identification information; and
provide a schedule that is included in the second schedule information as a recommended schedule in connection with the first schedule information.

8. The electronic device of claim 7, wherein the processor is configured to provide the schedule as the recommended schedule if there is no schedule information corresponding to a second time point after a first time point corresponding to the first schedule information.

9. The electronic device of claim 7, wherein the second identification information is a set of bit data including a bit corresponding to the first schedule information.

10. The electronic device of claim 7, wherein the first identification information is a first set of bit data or a first schedule name stored in connection with the first schedule information, and
wherein the second identification information is a second set of bit data or a second schedule name stored in connection with the second schedule information.

11. The electronic device of claim 7, wherein the processor is configured to determine as the second schedule information, from among the one or more pieces of schedule information, schedule information that corresponds to a second time point belonging to a specified time range from a first time point corresponding to the first schedule information.

12. A method for providing schedule performed at an electronic device, the method comprising:
identifying first schedule information corresponding to a first time point;
determining whether schedule information corresponding to a second time point is stored in a memory operatively connected with the electronic device, wherein the schedule information corresponding to the second time point belongs to a specified time range from the first time point;
providing, at the electronic device, a first schedule that is included in the schedule information as a recommended schedule corresponding to the second time point in connection with the first schedule information if the schedule information is stored in the memory; and
if the schedule information is not stored in the memory, selecting second schedule information based on identification information that is associated with the first schedule information from among pieces of schedule information stored in the memory, and providing, at the electronic device, a second schedule that is included in the second schedule information as the recommended schedule in connection with the first schedule information.

13. The method of claim 12, further comprising:
obtaining, at an application driven by the electronic device, the second schedule information; and
storing the second schedule in the memory.

14. The method of claim 12, further comprising:
storing the second schedule information in the memory in connection with the identification information based on execution both of a schedule included in the first schedule information and of the second schedule within a reference time by a user of the electronic device.

15. The method of claim 12, further comprising:
obtaining the second schedule information from an external device; and
storing the second schedule information in connection with the identification information.

16. The method of claim 12, further comprising:
extracting the second schedule information from a text output through a display of the electronic device or a message or an email that is sent and received.

17. The method of claim 12, further comprising:
storing another set of bit data that includes a bit corresponding to the first schedule in the memory in connection with the second schedule information if the identification information comprises a set of bit data.

18. The method of claim 12, wherein the identification information comprises at least one of a set of bit data or a schedule name corresponding to the first schedule information.

19. The method of claim 12, wherein the selecting of the second schedule information comprises:
selecting the second schedule information from the pieces of schedule information further based on time information corresponding to the second schedule information.

20. The method of claim 12, wherein the providing the second schedule comprises:
providing additional information associated with the second schedule.
